(19) United States
(12) Patent Application Publication
(10) Pub. No.: US 2025/0363348 A1
(43) Pub. Date: Nov. 27, 2025

(54) DEVICE AND METHOD OF REPARAMETRIZATING A RESIDUAL NETWORK FOR COMPUTATIONAL EFFICIENCY

(71) Applicant: Robert Bosch GmbH, Stuttgart (DE)

(72) Inventors: Martin Rapp, Esslingen Am Neckar (DE); Cecilia Eugenia De La Parra Aparicio, Herrenberg (DE); Nina Bretz, Kornwestheim (DE); Tobias Kirchner, Ludwigsburg (DE)

(21) Appl. No.: 19/038,742

(22) Filed: Jan. 28, 2025

(30) Foreign Application Priority Data
Feb. 23, 2024 (DE) 10 2024 201 689.6

(51) Int. Cl. G06N 3/08; G06N 3/048

(52) U.S. Cl. CPC G06N 3/08; G06N 3/048

(57) ABSTRACT

A computer-implemented method of reparametrizating a residual network. The residual network is a pre-trained neural network that includes residual connections that skip residual blocks. The method includes: evaluating a baseline performance of the residual network on a first data set; carrying out a loop while an application performance reduction with respect to the baseline performance is less than a given tolerable reduction, wherein the loop includes the following steps: selecting a residual block of the residual blocks for reparametrization; carrying out a second loop by the set i ∈ϵ, 2ϵ, . . . , 1: replace all non-linear activation functions fⱼ(x)∈b by new function fⱼ(x)=(1−ϵ)* fⱼ(x)+ϵ*x and perform retraining of M on a second data set; and reparameterize residual block b into a single layer.

### CROSS REFERENCE

The present application claims the benefit under 35 U.S.C. § 119 of German Patent Application No. DE 10 2024 201 689.6 filed on Feb. 23, 2024, which is expressly incorporated herein by reference in its entirety.

### FIELD

The present invention related to a method of reparametrizating a residual network and a method for operating an actuator by the reparametrized residual network, a computer program and a machine-readable storage medium, and a system.

### BACKGROUND INFORMATION

A Residual Neural Network (a.k.a. Residual Network, ResNet, see He, Kaiming, et al. “Deep residual learning for image recognition,” Proceedings of the IEEE conference on computer vision and pattern recognition, 2016) is a deep learning model in which the weight layers learn residual functions with reference to the layer inputs. From a practical perspective, a Residual Network is a network with at least one skip connection, also referred to as residual connection, that performs identity mapping, merged with the skipped layer(s) outputs by addition.

Residual connections are widely used in modern deep neural networks because they improve the trainability of networks. However, residual connections also greatly reduce the hardware efficiency of the network inference. The reason is that a forwareded activation by the residual connection needs to be kept in memory while computing the residual block. The residual block can be the skipped layer(s) by the residual connection. Typically, said activation needs to be stored in DRAM and loaded back to compute the addition. This results in additional load/store operations, leading to memory traffic becoming a bottleneck. Therefore, residual connections are beneficial during training, which is why they are widely used, but introduce inefficiency during inference.

There are conventional methods that use the advantages of residual connection during training and provides approaches to reduce or overcome the disadvantage of residual connections during inference.

The work of Jha et al. “Deepreduce: ReLU reduction for fast private inference” (ICML 2021) proposes to heuristically remove non-linear activation functions (e.g., ReLU) from the neural network (NN) using an importance score. The importance score is computed by training various variants of the NN with ReLU operations removed in different stages and observing the accuracy. The first optimization step removes all ReLU operations from some stages. The second step removes every second ReLU from selected other stages.

The work of Vasu et al. “MobileOne: An Improved One Millisecond Mobile Backbone” (CVPR 2023) proposes to design a special NN architecture that uses residual connections during training but reparameterizes them before inference into a residual-free network, while computing the same mathematical function. This is only possible by avoiding non-linear operations in the residual block, unlike established and widely used networks like ResNet, MobileNet, or EfficientNet architectures.

The work of Yu et al. “NetBooster: Empowering Tiny Deep Learning By Standing on the Shoulders of Deep Giants”, DAC 2023, does not target reducing the complexity of neural networks but targets improved training of networks by first inflating the network (replace a single layer by several layers with a nonlinear function in-between), then training the inflated network, and finally reducing the architecture back to the original topology. The final step is done by progressive linearization of the newly introduced non-linear activation functions: progressively interpolating between the activation function and the identity function until the activation function eventually can be removed and layers can be combined.

A drawback of the conventional methods is that they either require large computational and data resources to train many variants of the NN in order to compute the importance score, or requires developers to use a special non-standard neural network architecture already during training.

### SUMMARY

The present invention (data and compute) efficiently removes residual connections in trained neural network architectures for efficient inference while requiring only little computational and data resources.

In a first aspect, the present invention pertains to a computer-implemented method of reparametrizating a residual network. The residual network can be a pre-trained neural network that comprieses residual connections that skip residual blocks. A reparametrization can be understood as a re-configuration of the residual connection and residual block into a non-residual layer or non-residual layer sequence. In other words, a reparametrization can comprise a deleting of at least a residual connection and transforming the corresponding resuidal block of the deleted residual connection into a pure feed forward layer sequence or into one layer, wherein the layer sequence or layer can be regularly modified such that it effectively carries out essentially the same calculations as the residual connection in combination with the residual block. Thus, parameters, in particular weights, of the residual block are reparametrized to operate the reparametrized residual block without the residual connection such that the performance of the residual network essentially does not degrade or essentially outputs similar or identical activation as with the residual connection. The reparametrized residual block can comprise several originally layers that all or parts of them have been reparametrized or the originally layers of the residual block have been converted into one new layer performing essentially the same calculations as the residual connection in combination with the residual block.

According to an example embodiment of the present invention, the method starts with evaluating a baseline performance of the residual network on a first data set. The first data set is preferably be a small data set. The term small can be understood such that the dataset should be large enough to obtain reasonable performance estimates. This could require at least hundreds of images, more likely a few thousand. Still, this is small compared to usual training datasets that comprise millions of images.

This is followed by a step of carrying out a first loop while an application performance reduction with respect to the baseline performance is less than a given tolerable reduction, e.g. few percent like, 1%-5%.

The loop comprise the following steps: Selecting a residual block b of the residual blocks for reparametrization. Carrying out a second loop over a set i∈ϵ, 2∈, . . . , 1, where e is a step size, preferably expect 0.005<ϵ<0.1: Replace all non-linear activation functions fⱼ(x)∈b by new function fⱼ(x)=(1−ϵ)*fⱼ(x)+ϵ*x and perform a retraining of the linearized residual network on a second data set.

This is followed by a step of reparameterize the selected residual block b into a sequence of feed-forward layers or one single layer, e.g. like known from MobileOne and NetBooster. It is noted that progressive linearization can be used to remove non-linear activations. Linear operations can be reparameterized, that includes the most common operations like convolution, fully-connected layers, or BatchNormalization. This is followed by a step of evaluating the application performance of on the first data set and updating the performance reduction depending on application performance.

If the performance reduction is larger than the tolerable reduction, the current reparameterize is reversed and the first loop is terminated.

Finally, the reparametized residual network can be outputted or deployed on a targed device.

According to an example embodiment of the present invention, it is provided that the step of selecting a residual block be carried out depending on an estimated impact of the residual blocks on the application performance and/or of the residual blocks on the hardware efficiency, e.g on the targed device for inference. If the impact is smaller then a predefined threshold, then the residual block is seleced for reparametrization. The predefined threshold can be defined depending on the use-case of the residual network. The impact on the application performance and the impact on the hardware efficiency can be combined into a single metric used for residual block selection. This can be done with simple scalar functions like addition or multiplication applied to both impacts.

In a further aspect of the present invention, a computer-implemented method for using the reparametrized residual netword as a classifier for classifying sensor signals is provided. The classifier is adopted with the method according to any one of the preceeding aspects of the inventions, comprising the steps of: receiving a sensor signal comprising data from the imagining sensor, determining an input signal which depends on said sensor signal, and feeding said input signal into said classifier to obtain an output signal that characterizes a classification of said input signal.

In a further aspect of the present invention, a computer-implemented method for using the classifier trained for providing an actuator control signal for controlling an actuator is provided. An actuator control signal is determined depending on an output signal of the classification, which can be determined as described by the previous section. It is provided that the actuator controls an at least partially autonomous robot and/or a manufacturing machine and/or an access control system.

In a further aspect of the present invention, a control system for operating the actuator is provided. The control system comprises the classifier adopted according to any of the preceeding aspects of the present invention and is configured to operate the actuator in accordance with an output of the classifier.

Example embodiments of the present invention will be discussed with reference to the following figures in more detail.

### BRIEF DESCRIPTION OF THE DRAWINGS

FIG. 1 shows a schematic fusion of different layers into one final layer.

FIG. 2 shows a schematic residual block as part of a residual neural network.

FIG. 3 shows a flow diagram of an example embodiment of the present invention.

FIG. 4 shows a control system controlling an at least partially autonomous robot, according to an example embodiment of the present invention.

FIG. 5 shows a control system controlling a manufacturing machine, according ot an example embodiment of the present invention.

FIG. 6 shows a control system controlling an access control system, according to an example embodiment of the present invention.

FIG. 7 shows a control system controlling a surveillance system, according to an example embodiment of the present invention.

FIG. 8 shows a control system controlling an automated personal assistant, according to an example embodiment of the present invention.

FIG. 9 shows a control system controlling an imaging system, according to an example embodiment of the present invention.

FIG. 10 a training system, according to an example embodiment of the present invention.

### DETAILED DESCRIPTION OF EXAMPLE EMBODIMENTS

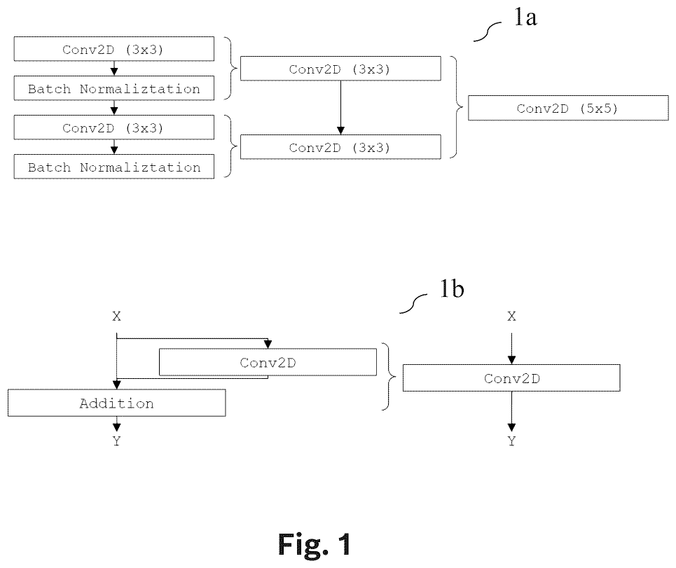

Layer fusion and reparameterization are conventional techniques, e.g. consecutive convolutional and Batch Normalization (BN) layers can be fused into a single convolutional layer because BN at inference time only performs a linear operation. FIG. 1 shows schematically a fusion (1a) of several convolutional layers Conv2D and Batch Normalization (BN) layers fused into a single Conv2D layer. Similarly, consecutive convolutional layers can be fused into a single Conv2D by combining the respective kernels into a new (bigger) kernel.

Residual branches without any non-linear activation function can be reparameterized (1b) into a single layer by modifying the kernel of the convolutional operation accordingly.

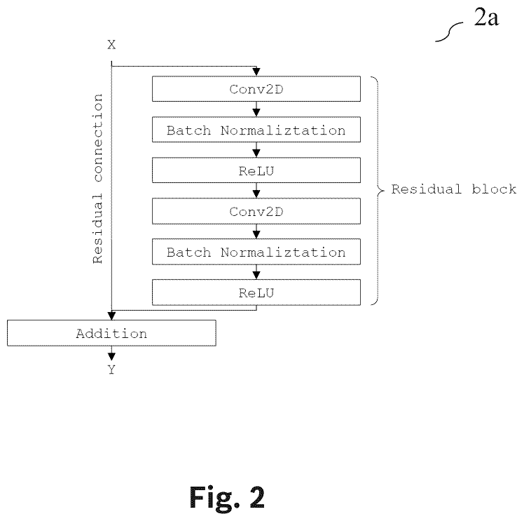

FIG. 2 exemplarily shows a part of a residual network. An input activation X of a previous part of the residual network, in particular of a previous layer of the residual network, is propagated through the residual block (2a) to receive an output activation Y. The residual block (2a) comprise a residual block, a residual connection and an Addition layer. The residual connection forwards the input activation X directly to the Additon layer and thereby skips the layer of the residual block. The residual block comprises one or a plurality of layers. The layers can be all possible layers utilized in existend deep neural networks. FIG. 2 exemplarily shows convolutional, ReLU as well as Batch Normalization layers. The output of the residual block and the forwarded input activation are merged in the Addition layer that outputs the output activation Y. The merging operation of the Addition layer can be a simple addition of both inputs of the Addition layer.

One goal of the present invention is to reparameterize some of the residual connections in a residual network such that preferably a Pareto-optimal trade-off between the application performance (e.g., maximize accuracy, minimize regression error) and the hardware efficiency of the inference (e.g., minimize memory traffic) is achieved, wherein a trained neural network is given that uses residual connections as well as a limited data set is available.

Typically, this goal is formulated as a constrained optimization, i.e., maximize the hardware efficiency while maintaining a certain application performance level. The main challenge is how to identify which residual blocks should be reparametrized.

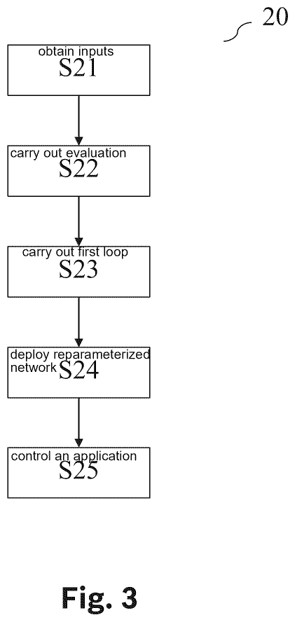

FIG. 3 exemplarily shows in an algorithmic way a method (20) for reparametrization of a residual network.

In the first step (S21) relevant inputs for the method are obtained, wherein the following items can be given:
a. M: a pre-trained model that uses residual connections,
b. Dₜ: a potentiallysmall labeled training dataset for short retraining,
c. L: loss function for training,
d. Dₜ: a potentially small labeled validation dataset to estimate the application performance (to get meaningful application performance numbers, this could be at least hundreds to thousands of images, but can be larger),
e. δ: the tolerable application performance reduction, and
f. ϵ: step size for progressive linearization (small number, as exemplarily given above).

In the second step (S22), an evaluation is carried out. The baseline application performance of M is evaluated on the small training data set and stored as P.

In the next step (S23), a first loop is carried out while the application performance reduction R is less than the tolerable reduction δ. The first loop comprise the following steps:
1. Identify a residual block b∈M to be linearize.
2. Carrying out a second loop for the set i∈ϵ, 2ϵ, . . . , 1:
   a. Replace all non-linear activation functions fⱼ(x)∈b by new function fⱼ(x)=(1−ϵ)*fⱼ(x)+ϵ*x for linearization.
   b. Perform short retraining of M using Dₜ and L
3. Reparameterize block b into a single convolutional layer. This is possible because block b does not have non-linear operations any more. MobileNet or NetBooster can be utilized.
4. Evaluate the application performance of M using Dᵥ and store the it as P′.
5. Update the performance reduction: R←P−P′.

After step S23 has been terminated, an optional step of deploying (S24) the reparametrized network to a target device for inference is carried out.

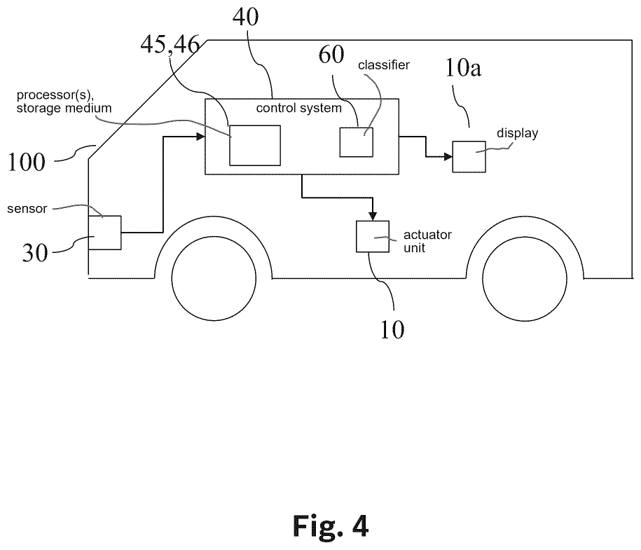

On the target device, the deployed network can be used for controlling (S25) an application, e.g. as exemplarily shown in the FIGS. 4 to 9.

A key challenge is how to identify blocks b∈M to linearize, which is the first step of the loop of S23. This requires to estimate the impact of block b on the application performance, and/or the impact of block b on the hardware efficiency, thereby considering limitations of the hardware.

There are several alternatives to compute these metrics. Combinations are possible, for instance by estimating the hardware cost of a block can be computed as “normalized size of feature map +normalized latency”. More generally, these individual scalar estimates can be combined using scalar operations like (weighted) averaging, etc.

In a first variant for computing the metric of the impact on the application, the metric is estimated by simple profiling. It comprises the following steps:
1) Evaluate baseline application performance of M and store it as P.
2) For each block b∈M that has not yet been reparameterized:
   a. Replace non-linear activation functions fⱼ(x)∈b by identity function gⱼ(x)=x.
   b. Evaluate the application performance of M using Dᵥ and store it as P_{b}.
   c. Revert change in activation functions.
3) Estimate impact of block b on the application performance as P−P_{b}.

In a second variant for computing the metric of the impact on the application, the metric is estimated by sensitivity analysis. It comprises the following steps:
1) For each block b∈M that has not yet been reparameterized:
   a. Introduce a new variable s_{b} to indicate the sensitivity.
   b. Replace non-linear activation functions fⱼ(x)∈b by identity function gⱼ(x, s_{b})=(1−s_{b})* fⱼ(x)+S_{b}*x.
   c. Initialize Sᵥ=0, such that gⱼ(x, s_{b})=fⱼ(x).
   d. Compute the gradient ∂/∂s_{b}L(Dᵥ, M).
   e. Revert change in activation functions
2) Estimate impact of block b on the application performance by S_{b}.

In a first variant for computing the metric of the impact on the hardware efficiency, the metric is estimated by a size of the residual feature map. It comprises the following steps:
1) For each block b∈M that has not yet been reparameterized:
   a. Compute size of the residual feature map x_{b} by |x_{b}|, which represents the cardinality of x_{b}.
2) Estimate impact of block b on the hardware efficiency as |x_{b}|.

In a second variant for computing the metric of the impact on the hardware efficiency, the metric is estimated by profiling of the block on real hardware/in simulation. It comprises the following steps:
1) For each block b∈M that has not yet been reparameterized:
   a. Profile the latency l for inference of this block.
2) Estimate impact of block b on the hardware efficiency as l.

In a third variant for computing the metric of the impact on the hardware efficiency, the metric is estimated by profiling of the block on real hardware/in simulation compared to the reparameterized block. It comprises the following steps:
1) For each block b∈M that has not yet been reparameterized:
   a. Profile the latency l_{orig} for inference of this block.
   b. Profile the latency l_{reparametrized} for inference of this block if reparameterized (this only requires knowing the architecture after reparameterization, not the weights).
2) Estimate impact of block b on the hardware efficiency as l_{orig}−l_{reparametrized}.

Finally, the impact on the application performance and the impact on the hardware efficiency can be combined into a single metric used for block selection. This can be done with simple scalar functions like addition or multiplication.

Shown in FIG. 4 is one embodiment of an actuator with a control system 40. Actuator and its environment will be jointly called actuator system. At preferably evenly spaced distances, a sensor 30 senses a condition of the actuator system. The sensor 30 may comprise several sensors. Preferably, sensor 30 is an optical sensor that takes images of the environment. An output signal S of sensor 30 (or, in case the sensor 30 comprises a plurality of sensors, an output signal S for each of the sensors) which encodes the sensed condition is transmitted to the control system 40.

Thereby, control system 40 receives a stream of sensor signals S. It then computes a series of actuator control commands A depending on the stream of sensor signals S, which are then transmitted to actuator unit 10 that converts the control commands A into mechanical movements or changes in physical quantities. For example, the actuator unit 10 may convert the control command A into an electric, hydraulic, pneumatic, thermal, magnetic and/or mechanical movement or change. Specific yet non-limiting examples include electrical motors, electroactive polymers, hydraulic cylinders, piezoelectric actuators, pneumatic actuators, servomechanisms, solenoids, stepper motors, etc.

Control system 40 receives the stream of sensor signals S of sensor 30 in an optional receiving unit 50. Receiving unit 50 transforms the sensor signals S into input signals.

Alternatively, in case of no receiving unit 50, each sensor signal S may directly be taken as an input signal. Input signal may, for example, be given as an excerpt from sensor signal S. Alternatively, sensor signal S may be processed to yield input signal. Input signal comprises image data corresponding to an image recorded by sensor 30. In other words, input signal is provided in accordance with sensor signal S.

Input signal is then passed on to an deployed network of step S24, which may, for example, be given by an artificial neural network. The deployed network can be a classifier 60.

Classifier 60 is parametrized by parameters, which are stored in and provided by parameter storage St₁.

Classifier 60 determines output signals y from input signals x. The output signal y comprises information that assigns one or more labels to the input signal. Output signals y are transmitted to an optional conversion unit 80, which converts the output signals y into the control commands A. Actuator control commands A are then transmitted to actuator unit 10 for controlling actuator unit 10 accordingly. Alternatively, output signals y may directly be taken as control commands A.

Actuator unit 10 receives actuator control commands A, is controlled accordingly and carries out an action corresponding to actuator control commands A. Actuator unit 10 may comprise a control logic which transforms actuator control command A into a further control command, which is then used to control actuator 10.

In further embodiments, control system 40 may comprise sensor 30. In even further embodiments, control system 40 alternatively or additionally may comprise actuator 10.

In one embodiment classifier 60 may be designed to identify lanes on a road ahead, e.g. by classifying a road surface and markings on said road, and identifying lanes as patches of road surface between said markings. Based on an output of a navigation system, a suitable lane for pursuing a chosen path can then be selected, and depending on a present lane and said target lane, it may then be decided whether vehicle 60 is to switch lanes or stay in said present lane. Control command A may then be computed by e.g. retrieving a predefined motion pattern from a database corresponding to said identified action.

Likewise, upon identifying road signs or traffic lights, depending on an identified type of road sign or an identified state of said traffic lights, corresponding constraints on possible motion patterns of vehicle 60 may then be retrieved from e.g. a database, a future path of vehicle 60 commensurate with said constraints may be computed, and said actuator control command A may be computed to steer the vehicle such as to execute said trajectory.

Likewise, upon identifying pedestrians and/or vehicles, a projected future behavior of said pedestrians and/or vehicles may be estimated, and based on said estimated future behavior, a trajectory may then be selected such as to avoid collision with said pedestrian and/or said vehicle, and said actuator control command A may be computed to steer the vehicle such as to execute said trajectory.

In still further embodiments, it may be envisioned that control system 40 controls a display 10a instead of an actuator 10, wherein the display 10a can display the control command or the like.

In other embodiments, the display 10a can be an output interface to a rendering device, such as a display, a light source, a loudspeaker, a vibration motor, etc., which may be used to generate a sensory perceptible output signal which may be generated based on the output of classifier 60. The sensory perceptible output signal may be directly indicative of the classification of classifier 60, but may also represent a derived sensory perceptible output signal, e.g., for use in guidance, navigation or other type of control of a computer-controlled system.

Furthermore, control system 40 may comprise a processor 45 (or a plurality of processors) and at least one machine-readable storage medium 46 on which instructions are stored which, if carried out, cause control system 40 to carry out a method according to one aspect of the invention.

In a preferred embodiment of FIG. 4, the control system 40 is used to control the actuator, which is an at least partially autonomous robot, e.g. an at least partially autonomous vehicle 100.

Sensor 30 may comprise one or more video sensors and/or one or more radar sensors and/or one or more ultrasonic sensors and/or one or more LiDAR sensors and or one or more position sensors (like e.g. GPS). Some or all of these sensors are preferably but not necessarily integrated in vehicle 100.

Alternatively or additionally sensor 30 may comprise an information system for determining a state of the actuator system. One example for such an information system is a weather information system which determines a present or future state of the weather in environment 20.

For example, using input signal, the classifier 60 may for example detect objects in the vicinity of the at least partially autonomous robot. Output signal y may comprise an information which characterizes where objects are located in the vicinity of the at least partially autonomous robot. Control command A may then be determined in accordance with this information, for example to avoid collisions with said detected objects.

Actuator unit 10, which is preferably integrated in vehicle 100, may be given by a brake, a propulsion system, an engine, a drivetrain, or a steering of vehicle 100. Actuator control commands A may be determined such that actuator (or actuators) unit 10 is/are controlled such that vehicle 100 avoids collisions with said detected objects. Detected objects may also be classified according to what the classifier 60 deems them most likely to be, e.g. pedestrians or trees, and actuator control commands A may be determined depending on the classification.

In further embodiments, the at least partially autonomous robot may be given by another mobile robot (not shown), which may, for example, move by flying, swimming, diving or stepping. The mobile robot may, inter alia, be an at least partially autonomous lawn mower, or an at least partially autonomous cleaning robot. In all of the above embodiments, actuator command control A may be determined such that propulsion unit and/or steering and/or brake of the mobile robot are controlled such that the mobile robot may avoid collisions with said identified objects.

In a further embodiment, the at least partially autonomous robot may be given by a gardening robot (not shown), which uses sensor 30, preferably an optical sensor, to determine a state of plants in the environment 20. Actuator unit 10 may be a nozzle for spraying chemicals. Depending on an identified species and/or an identified state of the plants, an actuator control command A may be determined to cause actuator unit 10 to spray the plants with a suitable quantity of suitable chemicals.

In even further embodiments, the at least partially autonomous robot may be given by a domestic appliance (not shown), like e.g. a washing machine, a stove, an oven, a microwave, or a dishwasher. Sensor 30, e.g. an optical sensor, may detect a state of an object which is to undergo processing by the household appliance. For example, in the case of the domestic appliance being a washing machine, sensor 30 may detect a state of the laundry inside the washing machine. Actuator control signal A may then be determined depending on a detected material of the laundry.

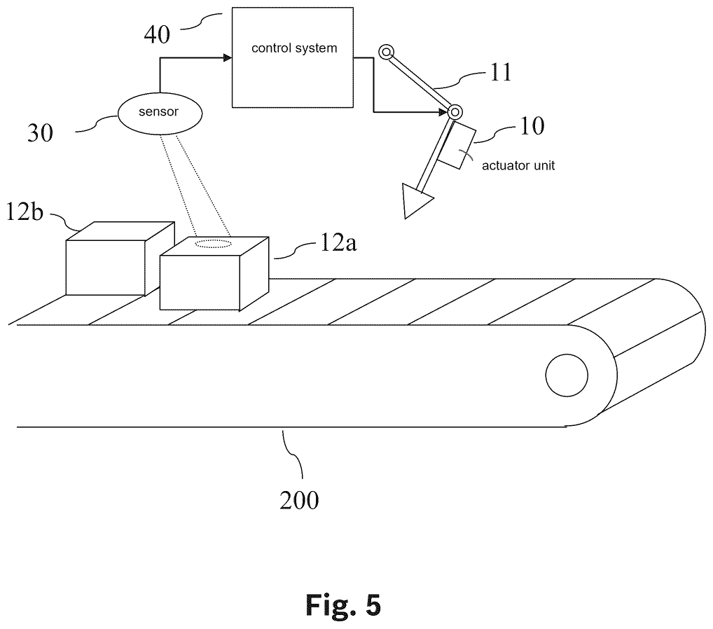

Shown in FIG. 5 is an embodiment in which control system 40 is used to control a manufacturing machine 11, e.g. a solder mounter, punch cutter, a cutter or a gun drill) of a manufacturing system 200, e.g. as part of a production line. The control system 40 controls an actuator unit 10 which in turn control the manufacturing machine 11.

Sensor 30 may be given by an optical sensor which captures properties of e.g. a manufactured product 12. Classifier 60 may determine a state of the manufactured product 12 from these captured properties. Actuator unit 10 which controls manufacturing machine 11 may then be controlled depending on the determined state of the manufactured product 12 for a subsequent manufacturing step of manufactured product 12. Or, it may be envisioned that actuator unit 10 is controlled during manufacturing of a subsequent manufactured product 12 depending on the determined state of the manufactured product 12.

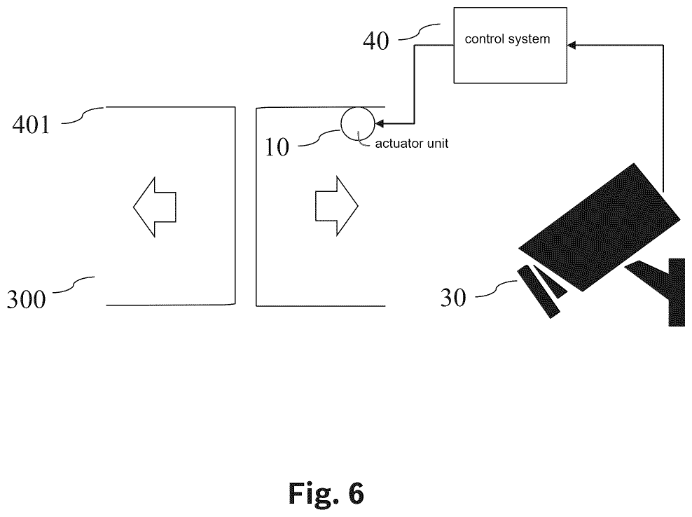

Shown in FIG. 6 is an embodiment in which control system controls an access control system 300. Access control system may be designed to physically control access. It may, for example, comprise a door 401. Sensor 30 is configured to detect a scene that is relevant for deciding whether access is to be granted or not. It may for example be an optical sensor for providing image or video data, for detecting a person's face. Classifier 60 may be configured to interpret this image or video data e.g. by matching identities with known people stored in a database, thereby determining an identity of the person. Actuator control signal A may then be determined depending on the interpretation of classifier 60, e.g. in accordance with the determined identity. Actuator unit 10 may be a lock which grants access or not depending on actuator control signal A. A non-physical, logical access control is also possible.

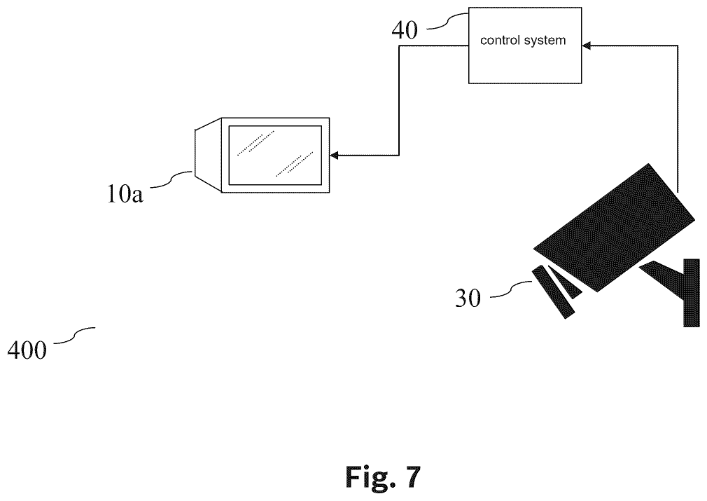

Shown in FIG. 7 is an embodiment in which control system 40 controls a surveillance system 400. This embodiment is largely identical to the embodiment shown in FIG. 5. Therefore, only the differing aspects will be described in detail. Sensor 30 is configured to detect a scene that is under surveillance. Control system does not necessarily control an actuator 10, but a display 10a. For example, the machine learning system 60 may determine a classification of a scene, e.g. whether the scene detected by optical sensor 30 is suspicious. Actuator control signal A which is transmitted to display 10a may then e.g. be configured to cause display 10a to adjust the displayed content dependent on the determined classification, e.g. to highlight an object that is deemed suspicious by machine learning system 60.

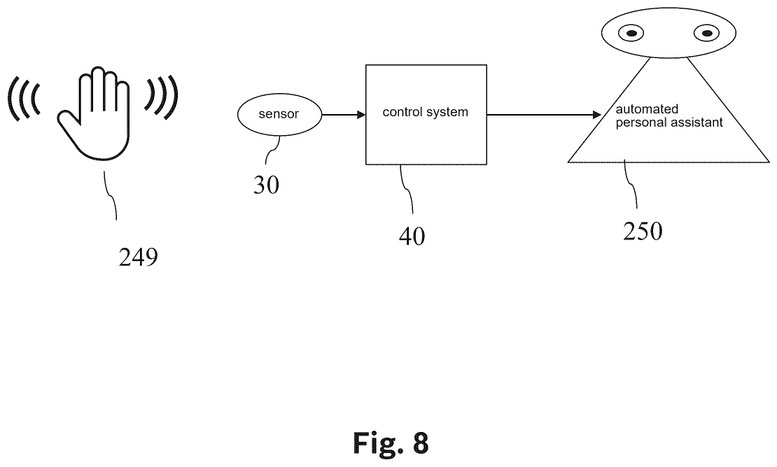

Shown in FIG. 8 is an embodiment in which control system 40 is used for controlling an automated personal assistant 250. Sensor 30 may be an optic sensor, e.g. for receiving video images of a gestures of user 249. Alternatively, sensor 30 may also be an audio sensor e.g. for receiving a voice command of user 249.

Control system 40 then determines actuator control commands A for controlling the automated personal assistant 250. The actuator control commands A are determined in accordance with sensor signal S of sensor 30. Sensor signal S is transmitted to the control system 40. For example, classifier 60 may be configured to e.g. carry out a gesture recognition algorithm to identify a gesture made by user 249. Control system 40 may then determine an actuator control command A for transmission to the automated personal assistant 250. It then transmits said actuator control command A to the automated personal assistant 250.

For example, actuator control command A may be determined in accordance with the identified user gesture recognized by classifier 60. It may then comprise information that causes the automated personal assistant 250 to retrieve information from a database and output this retrieved information in a form suitable for reception by user 249.

In further embodiments, it may be envisioned that instead of the automated personal assistant 250, control system 40 controls a domestic appliance (not shown) controlled in accordance with the identified user gesture. The domestic appliance may be a washing machine, a stove, an oven, a microwave or a dishwasher.

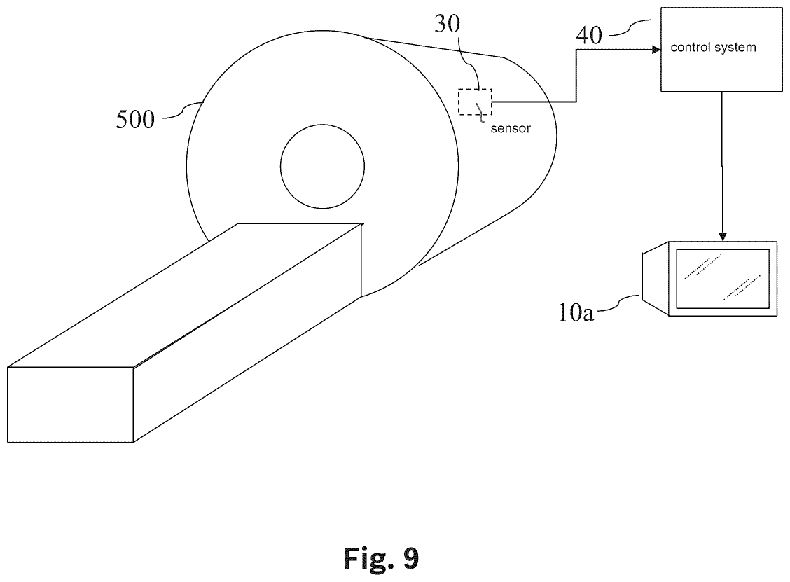

Shown in FIG. 9 is an embodiment of a control system 40 for controlling an imaging system 500, for example an MRI apparatus, x-ray imaging apparatus or ultrasonic imaging apparatus. Sensor 30 may, for example, be an imaging sensor. Machine learning system 60 may then determine a classification of all or part of the sensed image. Actuator control signal A may then be chosen in accordance with this classification, thereby controlling display 10a. For example, machine learning system 60 may interpret a region of the sensed image to be potentially anomalous. In this case, actuator control signal A may be determined to cause display 10a to display the imaging and highlighting the potentially anomalous region.

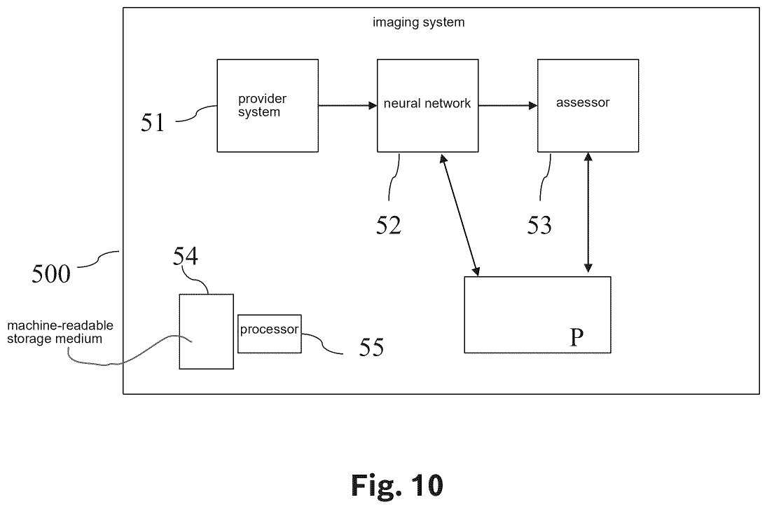

Shown in FIG. 10 is an embodiment of a training system 500. The training device 500 comprises a provider system 51, which provides input images from a training data set. Input images are fed to the neural network 52 to be trained, which determines output variables from them. Output variables and input images are supplied to an assessor 53, which determines acute hyper/parameters therefrom, which are transmitted to the parameter memory P, where they replace the current parameters. The assessor 53 is arranged to execute steps of FIG. 3.

The procedures executed by the training device 500 may be implemented as a computer program stored on a machine-readable storage medium 54 and executed by a processor 55.

The term “computer” covers any device for the processing of pre-defined calculation instructions. These calculation instructions can be in the form of software, or in the form of hardware, or also in a mixed form of software and hardware.

What is claimed is:

1. A computer-implemented method, comprising:
reparametrizating a residual network M, wherein the residual network M is a pre-trained neural network that includes residual connections that skip residual blocks, the reparametrizating including the following steps:
receiving a baseline performance of the residual network on a first data set Dᵥ;
carrying out a first loop while an application performance reduction with respect to the baseline performance s less than a given tolerable reduction, wherein the first loop includes the following steps:
a. selecting a residual block (b∈M) of the residual blocks for reparametrization,
b. carrying out a second loop over a set i∈ϵ, 2 ϵ, . . . , 1, wherein ϵ is a step-size smaller 1:
i. replacing non-linear activation functions fⱼ(x)∈b by new function fⱼ(x)=(1−ϵ)*fⱼ(x)+ϵ*x, and
ii. performing retraining of linearized residual network M on a second data set;
c. reparameterize residual block b with linear activation functions into one or several layers, and
d. evaluating the application performance of M on the first data set Dᵥ and updating the performance reduction depending on the application performance.

2. The method according to claim 1, wherein the step of selecting the residual block (b∈M) is carried out depending on an estimated impact of the residual blocks on the application performance and/or of the residual blocks on a hardware efficiency.

3. The method according to claim 2, wherein the estimated impact of the residual blocks on the application performance is estimated by evaluating the baseline application performance, wherein for each residual block that has not yet been reparameterized, the non-linear activation functions (fⱼ(x)) in resudial block are replaced with a identity function, wherein the application performance of the modified residual network with identity function is evaluated, wherein a change in activation functions is reverted, wherein the impact of the modifiedresidual block on the application performance is estimated as a difference between the baseline performance and the application performance of the modified residual network.

4. The method according to claim 2, wherein the estimated impact of the residual blocks on the application performance is estimated using the following steps:
for each residual block that has not yet been reparameterized, a variable (S_{b}) to indicate a sensitivity is initialized,
replacing the non-linear activation functions (fⱼ(x)) in the residual blocks by the identity function gⱼ(x, s_{b})=(1−s_{b})fⱼ(x)+s_{b}x;
initially, the variable (S_{b}) is set to zero,
computing gradients according to: ∂/∂s_{b}L(D, M), wherein L(D, M) is a loss function of the training of the residual network (M) for a given training data set (D),
reverting the change in activation functions, and
determining the impact of the modifiyed residual block on the application performance by the value of the variable (S_{b}).

5. The method according to claim 2, wherein the estimated impact of the residual blocks on the hardware efficiency is estimated using the following steps:
for each residual block that has not yet been reparameterized, computing a size of a residual feature map by counting a number of pixels, wherein the impact of residual block on the hardware efficiency is estimated as the size of the residual map.

6. The method according to claim 2, wherein the estimated impact of the residual blocks on the hardware efficiency is estimated using the following steps:
for each residual block that has not yet been reparameterized, a latency is determined for an inference of the residual blocks, wherein the impact of the residual block on the hardware is estimated as the latency.

7. The method according to claim 2, wherein the estimated impact of the residual blocks on the hardware efficiency is estimated using the following steps:
for each residual block that has not yet been reparameterized, determining a first latency for an inference of the residual block and determining a second latency for the inference of the residual block after it is reparameterized, wherein the impact of the residual block on the hardware efficiency is estimated as a difference between the first latency and the second latency.

8. The method according to claim 1, further comprising:
using the reparametrized residual network for classifying sensor signals, including the following steps:
receiving a sensor signal including data from a sensor,
determining an input signal which depends on the sensor signal; and
feeding the input signal into a classifer including the reparametrized residual network to obtain an output signal that characterizes a classification of the input signal.

9. The method according to claim 8, further comprising:
determining the actuator control signal depending on the output signal.

10. The method according to claim 9, wherein the actuator controls an at least partially autonomous robot and/or a manufacturing machine and/or an access control system.

11. A non-transitory machine-readable storage medium on which is stored a computer program, the computer program, when executed by a processor, causing the processor to perform the following steps:
reparametrizating a residual network M, wherein the residual network M is a pre-trained neural network that includes residual connections that skip residual blocks, the reparametrizating including the following steps:
receiving a baseline performance of the residual network on a first data set Dᵥ;
carrying out a first loop while an application performance reduction with respect to the baseline performance s less than a given tolerable reduction, wherein the first loop includes the following steps:
a. selecting a residual block (b∈M) of the residual blocks for reparametrization,
b. carrying out a second loop over a set i∈ϵ, 2ϵ, . . . , 1, wherein ϵ is a step-size smaller 1:
i. replacing non-linear activation functions fⱼ(x)∈b by new function fⱼ(x)=(1−ϵ)*fⱼ(x)+ϵ*x, and
ii. performing retraining of linearized residual network M on a second data set;
c. reparameterize residual block b with linear activation functions into one or several layers, and
d. evaluating the application performance of M on the first data set Dᵥ and updating the performance reduction depending on the application performance.

12. A system that is configured to perform a reparametrizating a residual network M, wherein the residual network M is a pre-trained neural network that includes residual connections that skip residual blocks, the reparametrizating including the following steps:
receiving a baseline performance of the residual network on a first data set Dᵥ;
carrying out a first loop while an application performance reduction with respect to the baseline performance s less than a given tolerable reduction, wherein the first loop includes the following steps:
a. selecting a residual block (b∈M) of the residual blocks for reparametrization,
b. carrying out a second loop over a set i∈ϵ, 2ϵ, . . . , 1, wherein ϵ is a step-size smaller 1:
i. replacing non-linear activation functions fⱼ(x)∈b by new function fⱼ(x)=(1−ϵ)*fⱼ(x)+ϵ*x, and
ii. performing retraining of linearized residual network M on a second data set;
c. reparameterize residual block b with linear activation functions into one or several layers, and
d. evaluating the application performance of M on the first data set Dᵥ and updating the performance reduction depending on the application performance.
